(19) United States
(12) Patent Application Publication
(10) Pub. No.: US 2002/0158603 A1
(43) Pub. Date: Oct. 31, 2002

(54) Portable power supply set

(75) Inventor: Cheng-Chung Chang, Taipei Shien (TW)

Correspondence Address: BACON & THOMAS, PLLC, 625 SLATERS LANE, FOURTH FLOOR, ALEXANDRIA, VA, 22314

(73) Assignee: Chain Tay Technology Co., Ltd., Taipei (TW)

(21) Appl. No.: 10/095,920

(22) Filed: Mar. 13, 2002

(30) Foreign Application Priority Data
Apr. 30, 2001 (TW) 090206938

(51) Int. Cl. H02J 7/00

(52) U.S. Cl. 320/107

(57) ABSTRACT

A light, small sized, handy portable power supply set having a replaceable adapter disclosed herein can supply power to a variety of portable electronic devices such as a personal computer, a personal digital assistant, and a digital camera.

### BACKGROUND OF THE INVENTION

1. Field of the Invention

The present invention relates to portable power supply set, and in particular, to portable power supply set having a replaceable power adapter for supplying power to a variety of portable electronic devices from a rechargeable power storage unit.

2. Description of the Prior Art

Following rapid development of computer science, various related products of the computer have become human auxiliary equipment in regular life, those equipment includes microprocessors, personal computers, and personal digital assistant (PDA) etc. Supplying power for these products are generally provided by a built-in rechargeable battery unit or separately installed dry battery unit. However, each product has its own compatible power supplier causes serious inconveniency that discourages people to use portable computer products and their peripheral equipment such as digital camera, recording pen, or cellular phone. Therefore, it is an urgent matter to develop a handy, portable and universally usable power supplying device for all kinds of portable computer products.

A conventional power supply set is designed in a limited function only compatible with its same series of products, for example, a portable power supply set made by Palm Co. can only be used to serve its own products or products of other cooperated manufactures. Such a blunt and exclusive commercialized policy is far apart from the moral point of view appreciative to customers.

Aiming at the above depicted problems, the present invention is to propose a remedy with a newly developed portable power supply set having a replaceable power adapter for supplying power to a variety of electronic devices from a rechargeable energy storage unit.

### SUMMARY OF THE INVENTION

It is an object of the present invention to provide a handy and space saving portable power supply set.

It is another object of the present invention to provide a portable power supply set whose energy storage unit is a common rechargeable battery unit.

It is still another object of the present invention to provide a portable power supply set which can supply power to a variety of load apparatuses such as a personal microprocessor, a digital camera, a personal digital assistant, a recording pen etc, with a replaceable power supply adapter.

To achieve these and other objects described above, the portable, power supply et of the present invention comprises: an upper cover; a lower case having an open port at its lower part which is protected by an upwardly openable lid, a drilled hole is provided at each side surface of the lower case; a power supply interface board formed of an electrical circuit board with two electric contactors, a power input terminal and a power output terminal provided at proper positions of the electrical circuit board, the electrical circuit board is further provided with a replaceable power adapter and a first intermediate connector, while the power adapter is attached with a second intermediate connector such that the power is supplied from the power source to the load electronic devices; and an electric energy storage unit. The upper cover and the lower case are coupled to form a housing wherein the power supply interface board is accommodated. The power input and output terminals are emerged from each of the two drilled holes provided on both sides of the lower case. The electric energy storage unit is inserted into the housing from the open port, and the two electrodes of the electric energy storage unit are contacted with two electric contactors of the circuit board respectively.

### BRIEF DESCRIPTION OF THE DRAWINGS

The above object and other advantages of the present invention will become more apparent by describing in detail a preferred embodiment of the present invention with reference to the attached drawings in which:

FIG. 1(A) is an upward view of the present invention;

FIG. 1(B) is a downward view of the present invention;

FIG. 2 is a three dimensional exploded view showing component parts of the present invention;

FIG. 3 is a drawing illustrating one embodiment of the present invention; and

FIG. 4 is a three dimensional exploded view of the power supply interface board of the present invention.

### DETAILED DESCRIPTION OF THE PREFERRED EMBODIMENT

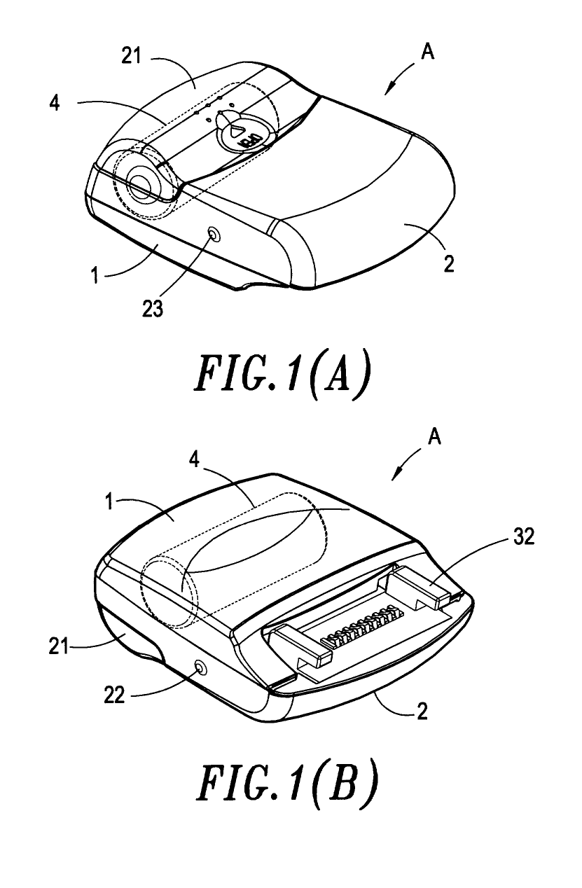

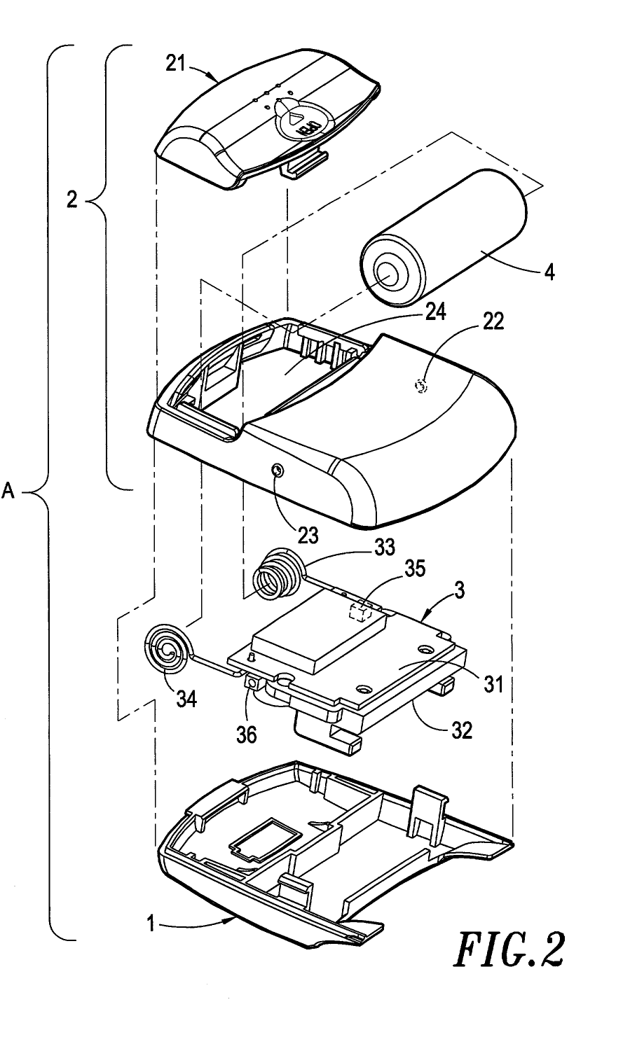

Referring to FIGS. 1(A), 1(B), and 2 simultaneously, it is clearly shown that the portable power supply set has a main body A composed of an upper cover 1, a lower case 2, a power supply interface board 3, and an electric energy storage unit (battery unit) 4. The lower case 2 is covered with the upper cover 1, and has an open port 24 at its lower part which is protected with an upwardly openable lid 21. A drilled hole 22 or 23 is provided at each side surface of the lower case 2. The power supply interface board 3 is essentially formed of a circuit board 31 with two electric contactors 33 and 34, a power input terminal 35 and a power output terminal 36 each provided at a proper position of the electric circuit board 31. The two electric contactors 33 and 24 are connected to two electrodes of the electric energy storage unit 4 respectively. The electric circuit board 31 has a power adapter 32. The power supply interface board 3 is installed in a housing formed by covering the upper cover 1 on the lower case 2. The power input and the power output terminals 35 and 35 are respectively emerged from the drilled holes 22 and 23. The electric energy storage unit 4 can be inserted into the housing from the port 24, and the two electrodes of the electric energy storage unit 4 are contacted with two electric contactors 33 and 34 respectively. The electric energy storage unit 4 is securely protected in the housing by closing tightly the lid 21 of the open port 24.

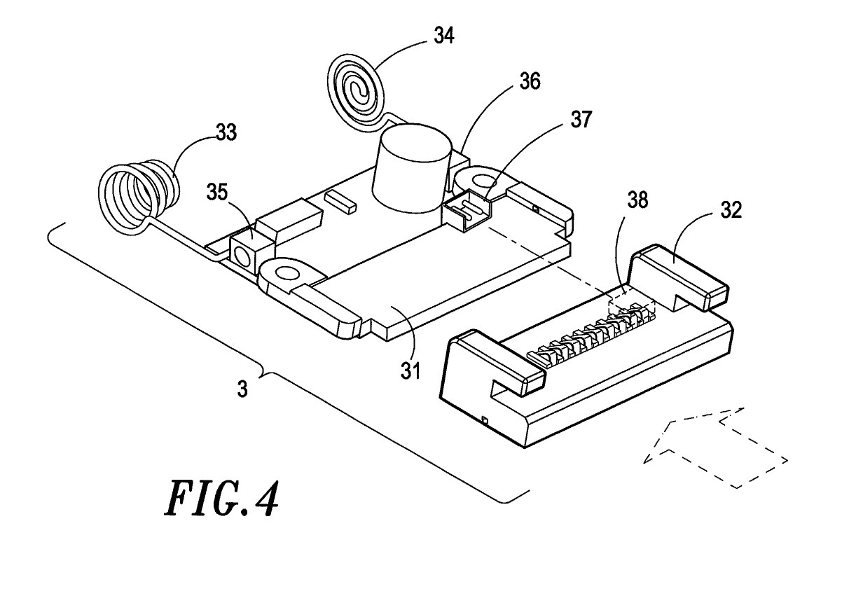

Referring to FIG. 4, a three dimensional exploded view of the power supply interface board of the present invention. The electrical circuit board 31 is provided with a first intermediate connector 37, while the power adapter 32 is provided with a second intermediate connector 38. The electric power is conducted from the circuit board 31 to the power adapter 32 by interconnecting the first and the second intermediate connectors 37 and 38 together. The power adapter 32 is designed in various types.

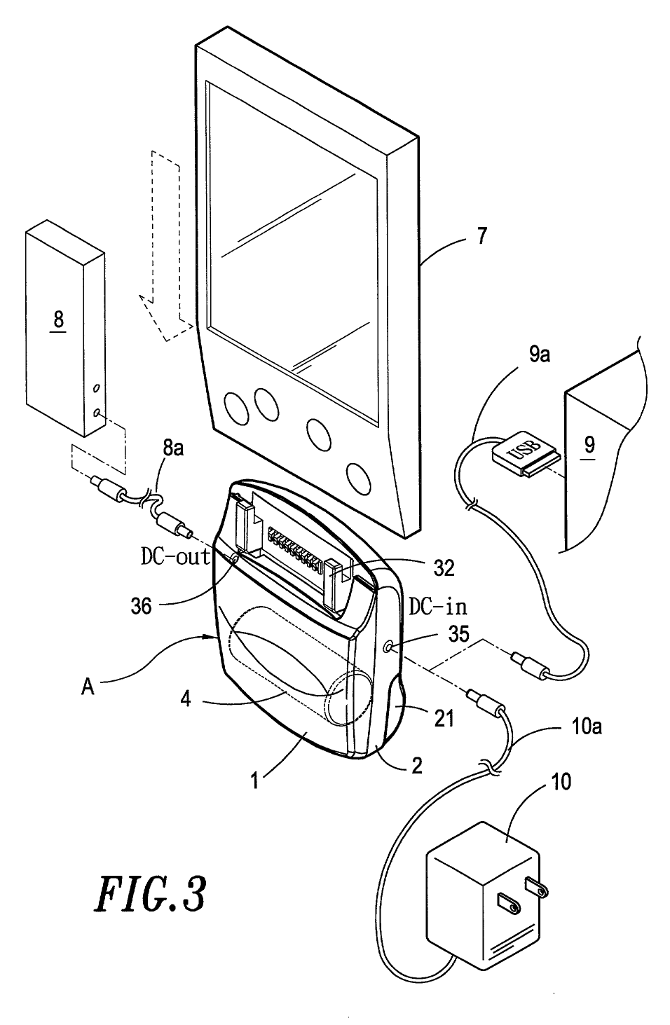

Returning to FIG. 3, a drawing illustrating an embodiment of the present invention, the power can be supplied to all kinds of portable computers 7, personal digital assistants, or other electronic devices by replacing the power adapter 32 in accordance with the load apparatuses. As shown in the drawing, the power needed for an electronic device 8 such as a digital camera can be obtained by inserting a lead conductor 8a into the power output contactor 36. The charging power of the energy storage unit 4 is obtained by connecting a lead conductor 9a to a computer power terminal 9 or a lead conductor 10a to a rectifying transformer (AC/DC adapter) 10.

It emerges from the description of the above embodiment that the invention has several noteworthy advantages, in particular:

1. The portable power supply set is handy and space sawing.

2. A common rechargeable battery unit can be used as the electric energy storage unit of the present invention.

3. Power can be supplied to a variety of portable electronic devices by replacing the power adapter.

While it will be apparent that the preferred embodiment of the present invention disclosed is well calculated to provide the advantages and features above stated, it will be appreciated that the invention is susceptible to modification, variation and change without departing from the proper scope or fair meaning of the subjoined claims.

What is claimed is:

1. Portable power supply set comprising: an upper cover; a lower case; a power supply interface board; and an electric energy storage unit;
said lower case has an open port at its lower part which being protected by an upwardly openable lid, a drilled hole is provided at each side surface of said lower case, said power supply interface board is formed of an electrical circuit board with two electric contactors, a power input terminal and a power output terminal are provided at proper positions of said electrical circuit board, said electrical circuit board is further attached with a power adapter, said upper cover and said lower case are coupled to form a housing wherein said power supply interface board is accommodated, said power input and said power output terminals are emerged from each of the two drilled holes provided on both sides of said lower case, said electric energy storage unit is inserted into said housing from said open port, and the two electrodes of said electric energy storage unit are contacted with said two electric contactors of said circuit board respectively.

2. Portable power supply set of claim 1, wherein said electrical circuit board is provided with a first intermediate connector, while said power adapter is provide with a second intermediate connector, the electricity is conducted from said circuit board to said power adapter by connecting said first and said second intermediate connectors, and said power adapter is replaceable.

3. Portable power supply set of claim 2, wherein the electric power is transmitted by interconnecting said first and said second intermediate connectors.

4. Portable power supply set of claim 1, wherein said power adapter is designed in various types connectable with a variety of portable computer and electronic devices for supplying power to said devices.

5. Portable power supply set of claim 1, wherein said power output terminal is able to supply electricity to an electrically driven device as a digital camera with a lead conductor.

6. Portable power supply set of claim 1, wherein said electric energy storage unit can be charged from a rectifying transformer (AC/DC adapter) by connecting said power input terminal and the rectifying transformer with a lead conductor.
